(19) United States
(12) Patent Application Publication
(10) Pub. No.: US 2019/0037908 A1
(43) Pub. Date: Feb. 7, 2019

(54) RIPENING AND EXTRUDING DEVICE WITH SERIES SCREW RODS FOR MAKING RICE NOODLES AND METHOD THEREOF

(71) Applicant: Central South University of Forestry and Technology, Changsha (CN)

(72) Inventors: Qinlu LIN, Changsha (CN); Simin ZHAO, Changsha (CN); Yunhui CHENG, Changsha (CN); Lizhong LIN, Changsha (CN); Huaxi XIAO, Changsha (CN); Tao YANG, Changsha (CN); Huiqiu CHEN, Changsha (CN); Lin ZHANG, Changsha (CN); Dong XU, Changsha (CN); Yuqin DING, Changsha (CN); Wei WU, Changsha (CN); Yue WU, Changsha (CN)

(21) Appl. No.: 16/052,847

(22) Filed: Aug. 2, 2018

(30) Foreign Application Priority Data
Aug. 3, 2017 (CN) 201710654450.6

(51) Int. Cl. A23P 30/20; A23L 7/113

(52) U.S. Cl. CPC A23P 30/20; A23V 2002/00; A23L 7/113

(57) ABSTRACT

A series screw rod ripening and extruding device for rice noodles production, and the device comprises a first-level screw rod self-ripening extruding machine and a second-level screw rod thread-extruding machine The invention also relates to a manufacturing method of rice noodles utilizing the series screw rod ripening extruder. The device of the present invention can be used to manufacture rice noodles, during which process ripening extrusion strength and shearing force increased, and the rich noodles made by this device contains plenty of gel. The production capacity is higher and it is energy-saving remarkably, the production efficiency is improved and furthermore, the device can be maintained conveniently.

### CROSS-REFERENCE TO RELATED APPLICATION

This application claims the benefit of priority under 35 U.S.C. § 119 to Chinese Patent Application No. CN201710654450.6, filed Aug. 3, 2017. The entire content of this application is hereby incorporated by reference herein.

### TECHNICAL FIELD

The present invention relates to a screw rod ripening and extruding device and the method thereof for food industry such as rice noodles production and the like.

### TECHNICAL BACKGROUND

At present, extruding machines commonly available in the market focus on plastics and there are fewer extruding machines used in food industry. Furthermore, the structure of extruding machines is complicated, and the extrusion strength applied on the materials is low, therefore the extrusion effect is poor. Conventional single-screw structure increases the extrusion efficiency, but the structure of the screw rod is complicated and the length is not satisfactory, and it's difficult to control the temperature of the outlet section, and thus the intensity of the manufactured rice gel is low and the production capacity is low. While the traditional double-screw structure achieves a good extrusion effect, it's very difficult to design and manufacture, and also inconvenient to maintain and operate, thereby reducing the service life of the device.

### SUMMARY OF INVENTION

In order to overcome the problems existing in current screw extruding machines, the technical problem to be solved by the present invention is to provide a screw rod ripening and extruding device for making rice noodles, with reasonable structure, stable performance, high extrusion strength, high capacity and long service life, and the rice noodles made by this device have plenty rice gel.

The technical solution adopted by the present invention to solve its technical problems is as follows.

A ripening and extruding device with series screw rods for rice noodles production, the device comprises a first-level screw rod self-ripening extruding machine and a second-level screw rod thread-extruding machine, the first-level screw rod self-ripening extruding machine comprises a first-level barrel, which comprises a first-level feeding inlet at one end and a first-level discharging outlet at the other end, the first-level barrel is provided with a self-ripening screw rod inside, which is coupled to a driving device I at one end; the second-level screw rod thread-extruding machine comprises a second-level barrel, which comprises a second-level feeding inlet at one end and a second-level discharging outlet at the other end, the second-level barrel is provided with a thread-extruding screw rod inside, which is coupled with the driving device II, the first-level discharging outlet is coupled to the second-level feeding inlet.

Further, the driving device I can include a motor I and a reduction gearbox I, and the said motor I is coupled to the reduction gear box I, which is coupled to one end of the self-ripening screw rod.

Further, the driving device II can include a motor II and a reduction gearbox II, and the said motor II is coupled to the reduction gear box II, which is coupled to one end of the thread-extruding screw rod.

Further, the self-ripening screw rod and the thread-extruding screw rod may be single-screw rods or double-screw rods.

Further, thread on the said self-ripening screw rod and the thread-extruding screw rod may be equal or unequal in length.

Further, the first-level discharging outlet and the second-level feeding inlet may both be funnel-shaped openings.

According to the present invention, the method of using the ripening and extruding device with series screw rods for rice noodles production, comprises a ripening stage and a thread-extruding stage.

During the said ripening stage, the operating temperature of the self-ripening screw rod in the first-level screw rod self-ripening extruding machine is in the range of 120-140 Celsius degress, the revolving speed of the self-ripening screw rod is 500-800 rpm, and the time required for the rice flour to be ripened and extruded from the first-level barrel is 2-12 seconds. During the thread-extruding stage, the operating temperature of the thread-extruding screw rod in the second-level screw rod thread-extruding machine is in the range of 60-90 Celsius degrees, the revolving speed of the thread-extruding screw rod is 30-150 rpm, and the time required for the rice flour to be extruded in form of threads (namely rice noodles) out the second-level barrel is 2-12 seconds.

The invention has reasonable structure, stable performance, high extruding intensity and long service life. The ripening extruding strength is increased and the shearing force is enhanced by using the invention to produce rice noodles. Using this invention, the produced rice noodles have plenty of gel, the production capacity is high and the energy is saved remarkably, and thereby the production efficiency is improved. The device is maintained conveniently. The invention can also be applied to other food industries.

### BRIEF DESCRIPTION OF THE DRAWINGS

FIG. 1 is a schematic structure view of the embodiment of the ripening and extruding device with series screw rods for production of rice noodles.

### EMBODIMENT

The following further describes the present invention with reference to the drawings and the embodiment.

### EXAMPLE

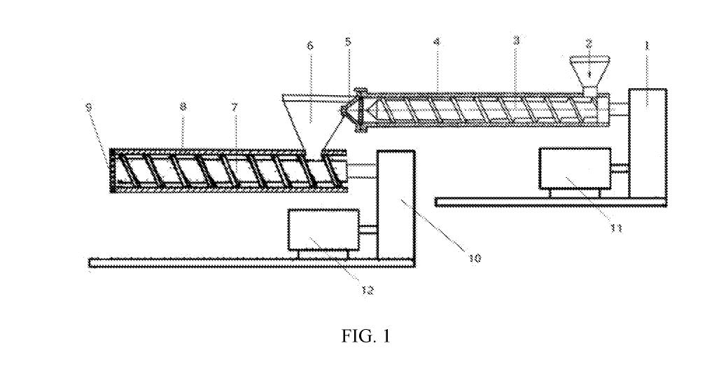

Referring to FIG. 1, in the embodiment a ripening and extruding device with series screw rods for production of rice noodles comprises a first-level screw rod self-ripening extruding machine and a second-level screw rod thread-extruding machine; the first-level screw rod self-ripening extruding machine comprises a first-level barrel 4, which comprises a first-level feeding inlet 2 at one end and a first-level discharging outlet 5 at the other end, the first-level barrel is provided with a self-ripening screw rod 3 inside, which is coupled to a reduction gearbox I 1 and motor I 11 at the feeding inlet end of screw rod 3; the second-level screw rod thread-extruding machine comprises a second-level barrel 8, which comprises a second-level feeding inlet 6 at one end and a second-level discharging outlet 9 at the other end, the second-level barrel 8 is provided with a thread-extruding screw rod 7 inside, which is coupled to a reduction gearbox II 10 and motor II 12 at the feeding inlet end, the first-level discharging outlet 5 is coupled to the second-level feeding inlet 6.

In the example, the self-ripening screw rod 3 and the thread-extruding screw rod 7 are single-screw rod. Of course, double-screw rods are also appropriate.

In the example, the length of thread on the said self-ripening screw rod 3 is the same as that of the thread-extruding screw rod 7. Of course, the length may be not the same.

In the example, the first-level discharging outlet 5 and the second-level feeding inlet 6 are both funnel-shaped openings.

According to the embodiment, the method of using the ripening and extruding device with series screw rods for rice noodles production, comprises ripening stage and thread-extruding stage. During the said ripening stage, the operating temperature of the self-ripening screw rod 3 in the first-level self-ripening screw rod extruding machine is 130 Celsius degrees, the revolving speed of the self-ripening screw rod 3 is 500-800 rpm, and the time required for the rice flour to be ripen and extruded from the first-level barrel 4 is 10 seconds. During the thread-extruding stage, the operating temperature of the thread-extruding screw rod 7 in the second-level screw rod thread-extruding machine is 80 Celsius degrees, the revolving speed of the thread-extruding screw rod 7 is 30-150 rpm, and the time required for the rice flour to be extruded in form of threads from the second-level barrel 8 is 8 seconds.

By utilizing the invention to manufacture rice noodles, the ripening extrusion strength is improved and the produced rice noodles have plenty of gel. The production capacity is high and efficient is increased. This invention can also be applied to other food industries.

1. A ripening and extruding device with series screw rods for rice noodles production, characterized that:
the device comprises a first-level screw rod self-ripening extruding machine and a second-level screw rod thread-extruding machine,
the first-level screw rod self-ripening extruding machine comprises a first-level barrel, which comprises a first-level feeding inlet at one end and a first-level discharging outlet at the other end, the first-level barrel is provided with a self-ripening screw rod inside, which is coupled to a driving device I at one end;
the second-level screw rod thread-extruding machine comprises a second-level barrel, which comprises a second-level feeding inlet at one end and a second-level discharging outlet at the other end, the second-level barrel is provided with a thread-extruding screw rod inside, which is coupled to a driving device II,
the first-level discharging outlet is coupled to the second-level feeding inlet.

2. The ripening and extruding device with series screw rods of claim 1, characterized that, the driving device I comprises a motor I and a reduction gearbox I, and the said motor I is coupled to the reduction gear box I, which is coupled to one end of the self-ripening screw rod.

3. The ripening and extruding device with series screw rods of claim 1, characterized that, the driving device II comprises a motor II and a reduction gearbox II, and the said motor II is coupled to the reduction gear box II, which is coupled to one end of the thread-extruding screw rod.

4. The ripening and extruding device with series screw rods of claim 1, characterized that, the said self-ripening screw rod and the thread-extruding screw rod may be single-screw rods or double-screw rods.

5. The ripening and extruding device with series screw rods of claim 1, characterized that, the thread on the said self-ripening screw rod and the thread-extruding screw rod may be equal or unequal in length.

6. The ripening and extruding device with series screw rods of claim 1, characterized that, the first-level discharging outlet and the second-level feeding inlet are both funnel-shaped openings.

7. A method of using the ripening and extruding device with series screw rods of claim 1 for rice noodles production, comprises ripening stage and thread-extruding stage,
during the said ripening stage, the operating temperature of the self-ripening screw rod in the first-level screw rod self-ripening extruding machine is in the range of 120-140 Celsius degrees, the revolving speed of the self-ripening screw rod is 500-800 rpm, and the time required for the rice flour to be ripen and extruded from the first-level barrel is 2-12 seconds, and
during the thread-extruding stage, the operating temperature of the thread-extruding screw rod in the second-level screw rod thread-extruding machine is in the range of 60-90 Celsius degrees, the revolving speed of the thread-extruding screw rod is 30-150 rpm, and the time required for the rice flour to be extruded in form of threads out the second-level barrel is 2-12 seconds.
